(19) United States
(12) Patent Application Publication
(10) Pub. No.: US 2013/0166695 A1
(43) Pub. Date: Jun. 27, 2013

(54) SYSTEM FOR PROVIDING INFORMATION-CENTRIC NETWORKING SERVICES BASED ON P2P AND METHOD THEREOF

(71) Applicant: Byung Joon LEE, Daejeon (KR)

(72) Inventor: Byung Joon LEE, Daejeon (KR)

(73) Assignee: Electronics and Telecommunications Research Institute, Daejeon (KR)

(21) Appl. No.: 13/614,679

(22) Filed: Sep. 13, 2012

(30) Foreign Application Priority Data
Dec. 27, 2011 (KR) 10-2011-0143383

(51) Int. Cl. G06F 15/16

(52) U.S. Cl. 709/219

(57) ABSTRACT

Disclosed are a system and a method for providing information-centric networking services based on P2P. The system for providing information-centric networking services based on P2P according to the present invention includes: when receiving a request for contents from a user, a first content node configured to request the contents using a plurality of address information for the requested contents; a plurality of second content nodes configured to provide the corresponding contents according to the request of the first content node; and a query server configured to select at least one second content node for requesting the contents among the plurality of second content nodes corresponding to each of the plurality of address information.

### CROSS-REFERENCE TO RELATED APPLICATIONS

This application claims priority to and the benefit of Korean Patent Application No. 10-2011-0143383 filed in the Korean Intellectual Property Office on Dec. 27, 2011, the entire contents of which are incorporated herein by reference.

### TECHNICAL FIELD

The present invention relates to an information-centric networking technology, and more particularly, to a system and a method for providing information-centric networking services based on P2P which are capable of identifying content data and distributing and storing positions of content data into a plurality of content nodes according to a P2P protocol and controlling a flow of content data based on a position list of content data through a separate server determining optimal content positions among several content positions.

### BACKGROUND ART

Recently, researches into new architecture for the future Internet have been actively conducted. As a representative architecture, there is a content centric network (CCN). The CCN technology, which is a technology proposed by VAN Jacobson of PARC, targets the new Internet architecture proposal that performs data transfer in a network using a name of data instead of the architecture of the current Internet using IP. An information-centric network (ICN) is collectively called a networking technology focusing data distributed through a network in addition to a content centric network. As the information-centric networking technology, there are PSRIP, Net-Inf, DONA, and the like, in addition to the aforementioned CCN.

The content transmission in the CCN is made through an interest packet that is a data request packet of a content user and a data packet that responds to data requested by a node having requested data. In this case, a behavior determining whether the interest packet is transferred via any node refers to as routing. A transfer path of the data packet is a reverse order of all the nodes that are circulated until the interest packet arrives at contents, and therefore the separate routing is not required.

FIG. 1 is a diagram showing a structure of two packets used in the CCN according to the related art. Referring to FIG. 1, the CCN has two packets, the interest packets and the data packets. A communication process between end users in the CCN will be described below. When the user wanting contents broadcasts the interest packets to which names of the user desired contents are subscribed, a router receiving the broadcast interest packets transfers the interest packets using a forwarding information base (FIB). That is, in the FIB term, when the names of the interest packets are searched, the router transfers the corresponding interest packets to a next node specified in the FIB. When the node having contents matching the names of the contents included in the interest packet receives the interest packets, the router transfers the data packets including the contents in a reverse direction of a path of the interest packet.

FIG. 2 is a diagram showing a structure of a router used in the CCN according to the related art. Referring to FIG. 2, when a large number of interest packets requesting the same data are received to a single router, only the first received interest packet is transferred to upper nodes that may transfer contents. In this case, the forwarding information base (FIB) stored in the router determines to which upper node the interest packets are transferred. After the interest packets art transferred, the router stores an interface receiving the interest packets and the names of the contents included in the interest packets in a pending interest table (PIT) in the router.

When the data packets enter the router from a data source, the router searches a PIT entry for determining whether names matched with the received data packets are present. Since the data requested by the user are reached when the matched names are present, the router forwards the received data packets to the corresponding interface into which the interest packets enter. The router deletes the searched PIT entry and stores the forwarded data packets in a content store therein.

The CCN router enables in-network caching of contents and thus is appropriate to reduce an amount of network backbone traffic and may easily understand the names used to identify the contents, and the structure of the router may be relatively simplified. Since the names are hierarchically configured, when the amount of data distributed through the network is increased, the FIB may be grouped according to the layer. As a result, the scalability may be easily secured as the number of branches of data distributed through the network is increased.

However, a typical CCN router extends a routing protocol used in the related art such as OSPF, and the like, so as to configure the FIB. However, when the FIB is configured using a distributed routing protocol such as OSPF, it is difficult to implement traffic engineering such as making a content transmission path different, and the like, according to a traffic distribution condition of a network.

### SUMMARY OF THE INVENTION

The present invention has been made in an effort to a system and a method for distributing and storing positions of contents to and in at least one content node according to a P2P protocol, searching a position list of contents by using the P2P protocol and transferring the corresponding position list to a separate query server to select optimal content positions, and transmitting and receiving contents to and from a content node by using the selected positions.

However, objects of the present invention are not limited the above-mentioned matters and other objects can be clearly understood to those skilled in the art from the following descriptions.

An exemplary embodiment of the present invention provides a system for providing information-centric networking services based on P2P, including: a first content node configured to request the contents using a plurality of address information for the requested contents when receiving a request for contents from a user; a plurality of second content nodes configured to provide the corresponding contents according to the request of the first content node; and a query server configured to select at least one second content node for requesting the contents among the plurality of second content nodes corresponding to each of the plurality of address information.

The first content node may provide the plurality of address information corresponding to each of the second content nodes for the contents acquired by using a P2P protocol to the query server, and request the contents to at least one second content node by selecting at least one second content node for requesting the contents among the plurality of second content nodes corresponding to each of the plurality of address information from the query server.

The first content node may inform that content transmission starts by transmitting an identifier of the first content node and identifiers of the second content nodes providing the contents to the query server, when receiving the contents.

The system for providing information-centric networking services based on P2P according to the present invention may further include: an information content node configured to store address information for the contents and provide the stored address information, wherein the first content node calculates keys for the requested contents, confirms information related to an information content node storing the address information for the contents by using the calculated keys, and accesses the information content node to receive the plurality of address information for the contents.

The system for providing information-centric networking services based on P2P according to the present invention may further include: a relay content node configured to relay packets for requesting the contents transmitted from the first content node and packets for providing the contents transmitted from the second content node.

The relay content node may store reverse transmission information for the packets for requesting the contents.

The query node may select at least one second contents node among the plurality of second content nodes corresponding to the plurality of address information according to at least one predetermined determination criterion.

Another exemplary embodiment of the present invention provides a system for providing information-centric networking services based on P2P, including: when receiving a request for contents from a user, an information providing unit configured to receive a plurality of address information for the requested contents; a node determining unit configured to determine at least one content node for requesting the contents among a plurality of content nodes corresponding to each of the plurality of address information; and a content processing unit configured to request the contents to at least one determined content node and receive the requested contents from at least one content node.

The information providing unit may calculate keys for the requested contents, confirms information related to an information content node storing the address information for the contents by using the calculated keys, and access the information content node to receive address information for the contents.

The node determining unit may provide the plurality of received address information for the contents to a query server and request the contents to at least one second content node by selecting at least one second content node for requesting the contents among the plurality of second content nodes corresponding to each of the plurality of address information from the query server.

Yet another exemplary embodiment of the present invention provides a method for providing information-centric networking services based on P2P, including: when receiving a request for contents from a user, receiving, by a first content node, a plurality of address information for receiving the requested contents through a P2P protocol; selecting, by a query server, at least one second content node for requesting the contents among a plurality of second content nodes corresponding to each of the plurality of address information; requesting, by the first content node, the contents to at least one selected second content node; and providing, by at least one second content node, the requested contents.

In the receiving, the first content node may calculate keys for the requested contents, confirm information related to an information content node storing the address information for the contents by using the calculated keys, and access the information content node to receive the plurality of address information for the contents.

In the selecting, the first content node may provide the plurality of received address information for the contents to the query server and select at least one second content node for requesting the contents among the plurality of second content nodes corresponding to each of the plurality of address information from the query server.

The method for providing information-centric networking services based on P2P according to the present invention may further include: informing, by the first content node, that content transmission starts by transmitting an identifier of the first content node and identifiers of the second content nodes providing the contents to the query server, when receiving the contents.

The providing may include: transmitting, by a relay content node, packets for requesting the contents transmitted from the first content node to the second content nodes; and transmitting, by the relay content node, packets for providing the contents transmitted from the second content nodes to the first content node.

The method for providing information-centric networking services based on P2P according to the present invention may further include: storing, by the relay content node, reverse transmission information for the packets for requesting the contents.

In the selecting, the query server may select at least one second content node among the plurality of second content nodes according to at least one predetermined determination criterion.

Still another exemplary embodiment of the present invention provides a method for providing information-centric networking services based on P2P, including: when receiving a request for contents from a user, receiving a plurality of address information for the requested contents; requesting the contents to at least one content node among the plurality of content nodes corresponding to each of the plurality of address information; and receiving the requested contents from at least one content node.

In the receiving, keys for the requested contents may be calculated, information related to an information content node storing the address information for the contents by using the calculated keys may be confirmed, and the address information for the contents may be received by accessing the information content node.

In the requesting, the plurality of received address information for the contents may be provided to the query server, and at least one second content node for requesting the contents among the plurality of second content nodes corresponding to each of the plurality of address information may be selected from the query server to request the contents to at least one selected second content node.

According to the exemplary embodiments of the present invention, it is possible to achieve the scalability upon processing a large amount of content data by identifying the positions of the content data according to the P2P protocol and distributing and storing the positions of the content data in the plurality of content nodes.

The exemplary embodiments of the present invention may be implemented without greatly correcting the IP data plane by identifying the positions of the content data according to the P2P protocol and distributing and storing the positions of the content data in the plurality of content nodes, thereby making it possible to save operational costs to construct the service network.

According to the exemplary embodiments of the present invention, it is possible to secure the scalability according to the number of content data by identifying the positions of the content data according to the P2P protocol and distributing and storing the positions of the content data in the plurality of content nodes.

According to the exemplary embodiments of the present invention, it is possible to enable the traffic engineering for improving data link utilizations by controlling the flow of the content data based on the position list of the content data in the separate server.

According to the exemplary embodiments of the present invention, it is possible to easily distribute the content data in the network by controlling the flow of the content data based on the position list of the content data in the separate server.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram showing a structure of two packets used in a CCN according to the related art.

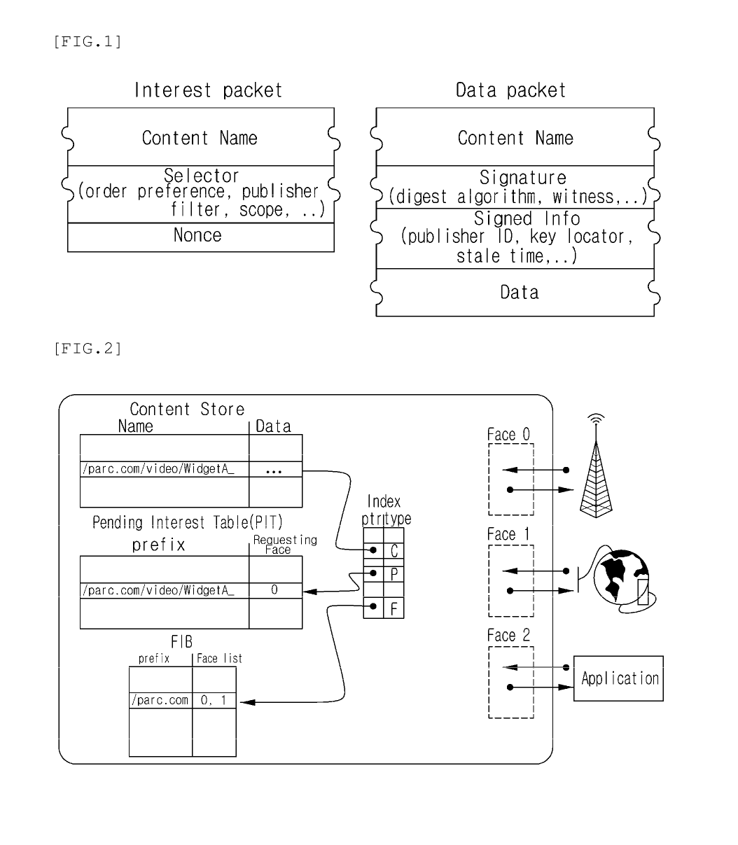

FIG. 2 is a diagram showing a structure of a router used in the CCN according to the related art.

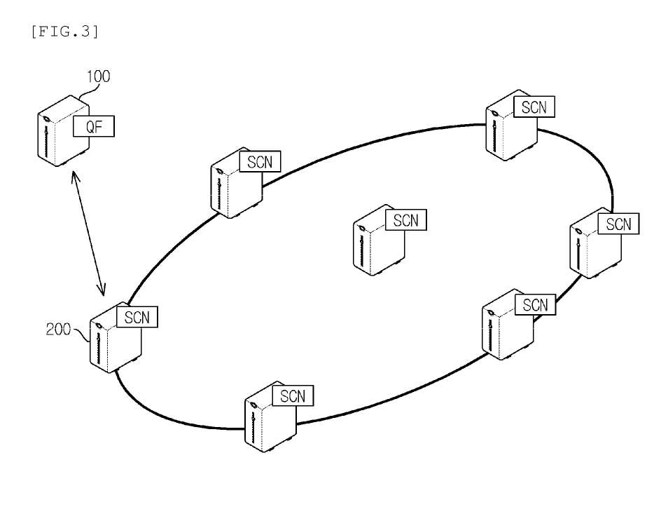

FIG. 3 is a diagram showing a system for providing data services according to an exemplary embodiment of the present invention.

FIG. 4 is a diagram showing a detailed configuration of a content node 200 shown in FIG. 3.

FIG. 5 is a diagram showing a detailed configuration of a query server 100 according to an exemplary embodiment of the present invention.

FIG. 6 is a diagram showing a method for providing data services according to an exemplary embodiment of the present invention.

FIGS. 7A to 7D are diagrams showing an operational principle for providing data services according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, positions, and shapes will be determined in part by the particular intended application and use environment.

In the figures, reference numbers refer to the same or equivalent parts of the present invention throughout the several figures of the drawing.

### DETAILED DESCRIPTION

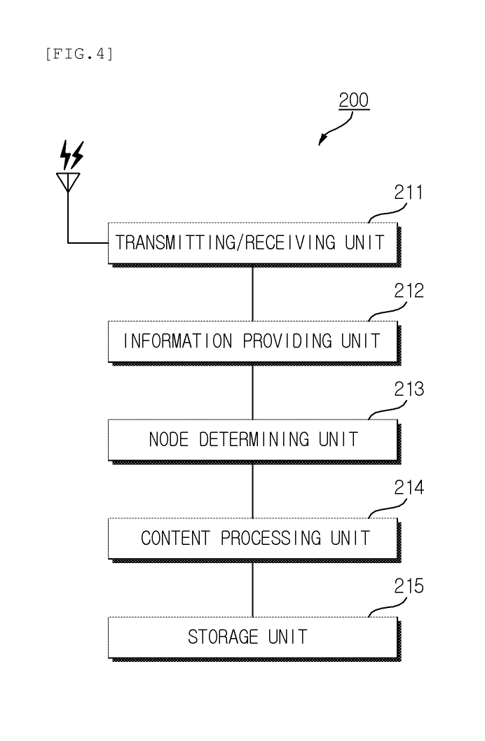

Hereinafter, a system and a method for providing information-centric networking services based on P2P according to exemplary embodiments of the present invention will be described with reference to FIGS. 3 to 7. Components required to understand an operation and an action according to the exemplary embodiments of the present invention will be described in detail. Throughout the specification, components are denoted by reference numerals shown in each drawing.

The present invention proposes a new method for identifying positions of content data according to a peer to peer (P2P) protocol, distributing and storing the positions of content data in a plurality of content nodes configuring a network, and allowing a separate server to control a flow of content data based on a position list of content data.

In this case, the P2P protocol is a bidirectional communication protocol of a type that all the participating nodes are both content suppliers and demanders. The P2P protocol type is not defined but may be variously defined as needed.

FIG. 3 is a diagram showing a system for providing data services according to an exemplary embodiment of the present invention.

As shown in FIG. 3, a system for providing data services according to an exemplary embodiment of the present invention may be configured to include a query server 100, a plurality of content nodes 200, and the like. Here, content information, for example, keys for contents, identification information including names of contents, positional information of contents, and the like, may be distributed and stored to and in several content nodes 200 on an information-centric network using a P2P protocol.

In this case, the keys for contents are values used to fetch the information of contents using the P2P protocol and may use values obtained by hashing the identification information of contents such as names of contents, distributors of contents, versions of contents, and the like. What values are used as the keys depends on what P2P protocol is used. Hereinafter, a case of using a distributed hash table (DHT) as the P2P protocol will be described by way of example.

A DHT algorithm means a distributed system that each node in the system manages a specific part of hash space of DHT to which keys are mapped. As positional information, an Internet protocol address, and the like, may be used.

The query server 100, which is a portion of the information-centric network, is a server that may search a network topology of the information-centric network and a traffic distribution condition. Herein, the query server 100 may be referred to as a query function (QF). The QF may determine content nodes optimal to fetch contents by a method similar to a method proposed in an ALTO standard of IETF.

The content node 200, which is an apparatus that may process a request for contents, that is, receive a request for contents from a user to provide content services to the user requesting the contents based on the corresponding contents, may be referred to as, for example, a smart content node (SCN).

Information-centric networking may be realized by the information-centric network that is configured by a collection of the SCN devices.

The content node 200 may be divided into a first content node 210 receiving a request for contents from the user, an information content node 220 providing information of a node storing contents, a relay content node 230 relaying a packet for requesting contents and a packet for providing contents, and second content nodes 240 providing the requested contents according to the function, which will be described below.

The first content node 210 may communicate with the query server 100 for processing the user request for contents, the information content node, the relay content node, and the second content nodes. That is, the first content node 200 finds out the positions of the content nodes (i.e., the second content nodes) having the corresponding contents by using the P2P protocol when receiving a request for contents from the user and then, queries an optimal node for receiving the requested contents in the corresponding position list to the query server 100 to receive the information related to at least one second content node 240 that is optimized to fetch the contents from the query server 100 as a response to the query. Thereafter, the first content node 210 may receive the contents from the second content nodes 240.

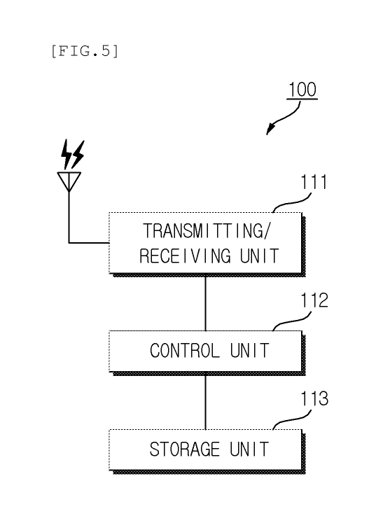

FIG. 4 is a diagram showing a detailed configuration of the content node 200 shown in FIG. 3.

As shown in FIG. 4, the content node 200 according to the exemplary embodiment of the present invention may be configured to include a transmitting/receiving unit 211, an information providing unit 212, a node determining unit 213, a content processing unit 214, a storage unit 215, and the like. In this case, the first content node 210, the information content node 220, the relay content node 230, and the second content nodes 240 have the same configuration but different functions, and therefore will be described separately.

1) An operation of requesting the contents of the first content node will be described as follows. The transmitting/receiving unit 211 may communicate with the query server, the information content node, the relay content node, and the second content nodes. The transmitting/receiving unit 211 may be a physically single apparatus but may be divided into a plurality of transmitting/receiving units that are physically separated for communicating with the query server, the information content node, the relay content node, and the second content nodes, respectively.

When the information providing unit 212 receives a request for contents from the user, access information for contents, that is, information related to the second content nodes storing the keys and a pair of content identification information and positional information may be confirmed. That is, the information providing unit 212 may calculate the keys for the corresponding contents from the identification information of the requested contents and confirm the access information for the corresponding contents, for example, the information related to the second content nodes storing the IP address by using the calculated keys.

That is, the exemplary embodiment of the present invention calculates the keys generated from the identification information for contents when using the DHT and determines based on the hashing function of the DHT whether the pair of content identification information and keys and the pair of content identification information and positional information is stored in what second content node by applying the corresponding keys to the hashing function of the DHT. Therefore, when the keys are calculated from the content identification information, the keys are set as the input of the DHT, and thus it is possible to receive the information for the information contents node storing the content information as the output.

The information providing unit 212 may access the information content node according to the access information and receive the address information of the pair of identification information and positional information for the contents requested by the user from the information content node.

In this case, when the same contents are stored in the plurality of second content nodes, the information providing unit 212 may receive the address information of the plurality of second content nodes from the information content node, respectively.

The node determining unit 213 may transmit the received address information of the plurality of second content nodes to the query server and query whether it is optimal from which of the second content nodes corresponding to a plurality of address information the content services are received.

When one second content node is selected as the queried results from the query server, the content processing unit 214 may transmit the interest packets for requesting the contents requested from the user to the selected second content node. Here, the interest packet may include the identification information of contents and may also include the keys for contents together with the identification information of contents.

The content processing unit 214 may receive the contents requested from the second content nodes and may provide the received contents to the user. The received content may be stored in the storage unit 215.

2) An operation of providing the address information of the information content node will be described as follows.

The transmitting/receiving unit 211 may communicate with the first content node. The transmitting/receiving unit 211 may receive a request for the address information of the second content nodes having the contents requested by the user from the first content node and provide the requested address information. The information providing unit 212 may search the requested address information in the storage unit 215 and provide the searched address information.

3) An operation of relaying the packets of the relay content node will be described as follows.

The transmitting/receiving unit 211 may communicate with the first content node and the second content nodes. The transmitting/receiving unit 211 may receive the interest packet from the first content node and transmit the received interest packet to the second content nodes or may receive the data packets from the second content nodes and transmit the received data packet to the first content node.

When receiving an interest packet, the information providing unit 212 searches whether the corresponding content is stored in the storage unit 215 and if it is determined that the contents is not present, forwards the interest packet and stores the reverse transmission information for the interest packet for preparing the case in which the data packet for the interest packet is received later. However, if the requested content is present in the storage unit 215, the information providing unit 212 sends the content as a reply to the interest packet.

4) An operation of providing the contents of the second content nodes will be described as follows.

The transmitting/receiving unit 211 may communicate with the first content node. The transmitting/receiving unit 211 may receive a request for the contents requested by the user from the first content node and may provide the requested contents.

The information providing unit 212 may also store at least one content. In this case, when the first content node accesses the information providing unit 212 to request the specific contents, the information providing unit 212 searches the corresponding contents in the storage unit 215 and may provide the data services for the corresponding contents according to the searched results.

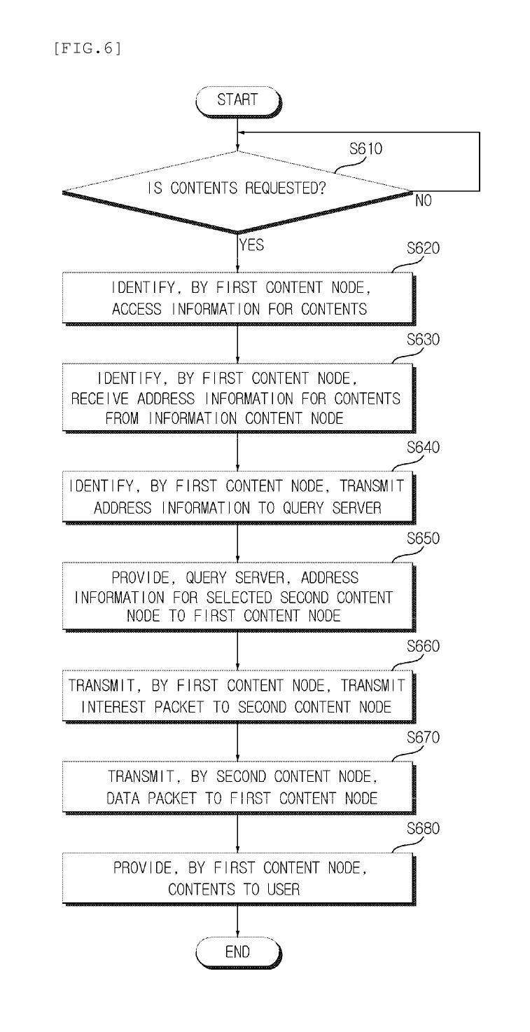

FIG. 5 is a diagram showing a detailed configuration of the query server 100 according to an exemplary embodiment of the present invention.

As shown in FIG. 5, according to the exemplary embodiment of the present invention, the query server 100 may select at least one optimal second content node among the plurality of second content nodes, and may be configured to include a transmitting/receiving unit 111, a control unit 112, and a storage unit 113, and the like.

The transmitting/receiving unit 111 may receive the plurality of address information from the first content node, including the address of the first content node.

The control unit 112 may select at least one optimal second content node among the second content nodes corresponding to the received plurality of address information the data services are received, according to at least one predetermined determination criterion. Here, the determination criterion may include proximity to the first content node, a load of a node, a bandwidth usage of an inter-node link, and the like.

For example, 1) when using the proximity as the criterion, the control unit 112 may align the second content nodes in the increasing order of geographical distances to the first content node to select the second content nodes closest to the first content node according to the aligned results.

2) When using the proximity and the load of the node as the criterion, the control unit 112 may align the second content nodes in the increasing order of geographical distances to the first content node and again align the predetermined number of second content nodes selected according to the aligned results in the increasing order of load to select the second content nodes having the smallest load according to the aligned results.

3) When using the proximity, the load of the node, and the bandwidth usage of the inter-node link as the criterion, the control unit 112 may align the second content nodes in the increasing order of geographical distances to the first content node, again align the predetermined number of second content nodes selected according to the aligned results in the increasing order of load, and again align the second content nodes of a predetermined threshold value or less according to the aligned result in the increasing order of bandwidth usage to select the second content nodes having the smallest bandwidth usage, that is, the largest usable bandwidth according to the aligned result.

The storage unit 113 may store at least one predetermined determination criterion and a selection method. In this case, the selection method may be applied when using at least two determination criteria. For example, the selection method may represent 1) whether to use the load of the node after performing alignment based on the proximity, or 2) whether to use the proximity after performing alignment based on the load of the node.

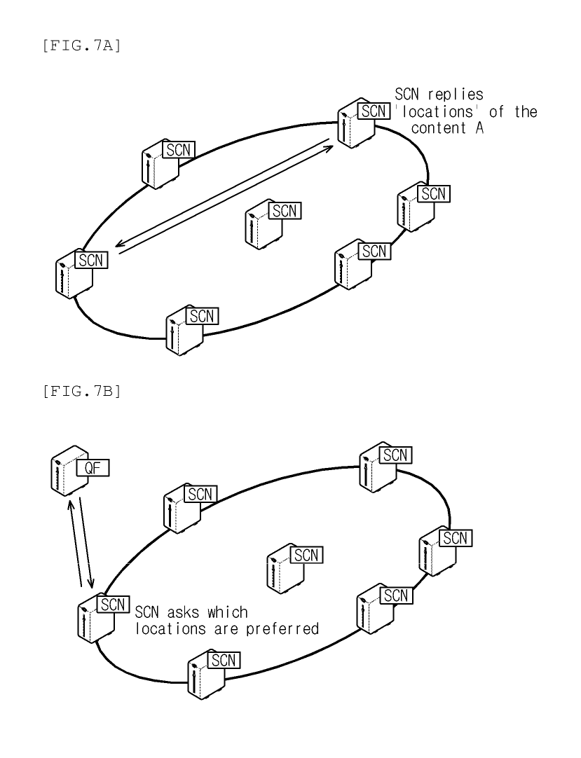

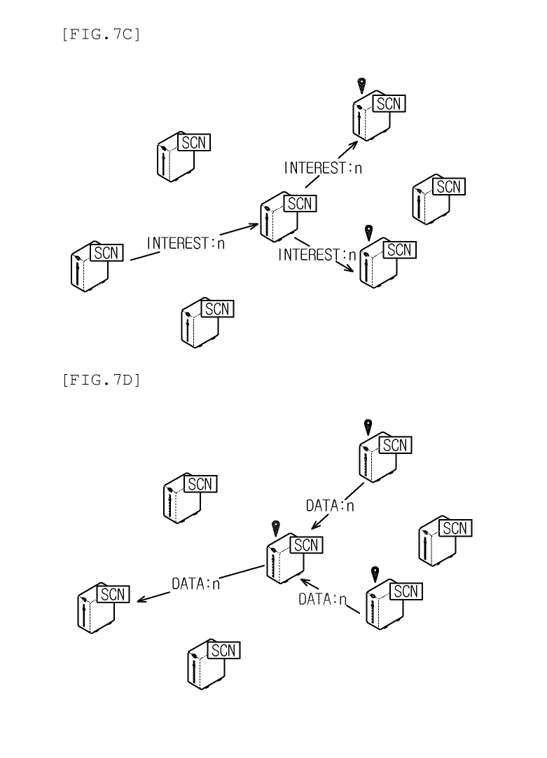

FIG. 6 is a diagram showing a method for providing the information-centric networking services according to an exemplary embodiment of the present invention, and FIGS. 7A to 7D are diagrams for describing an operation principle for providing the information-centric networking services according to the exemplary embodiment of the present invention.

Referring to FIGS. 6 and 7A to 7D, when the first content node according to the exemplary embodiment of the present invention receives a request for the contents from the user (S610), it may confirm the access information for the received contents (S620). That is, the first content node may calculate the keys for the requested contents and confirm the access information identification information and the positional information for the corresponding content, for example, the positional information of the information content node storing the IP addresses by using the calculated keys.

Next, as shown in FIG. 7A, the first content node may access the information content node by using the identified positional information of the information content node and receive the address information for the contents requested by the user from the information content node (S630).

Next, as shown in FIG. 7B, the first content node may transmit the plurality of received address information to the query server to query whether it is optimal from which of the second content nodes corresponding to the plurality of address information the content services are received (S640).

Next, the query server may select at least one second content node among the second content nodes corresponding to the plurality of received address information the data services are received, according to at least one predetermined determination criterion. The query server may provide the address information for the selected one second content node as the response for the query (S650).

In this case, the query server may select at least one second content node, and therefore the plurality of address information may be provided.

Next, as shown in FIG. 7C, when receiving the address information from the query server, the first content node may transmit the interest packets for requesting the contents requested from the user to the second content nodes previously selected according to the received address information through at least one relay content node (S660).

In this case, the first content node may receive the plurality of address information from the query server and thus may transmit the plurality of interest packets to different ports.

In this case, the relay content node that does not have the contents corresponding to the interest packets forwards the interest packets and stores the reverse path information for the corresponding interest packets for preparing the case in which the data packets are transmitted later.

Next, as shown in FIG. 7D, when receiving the interest packets, the second content nodes may search the contents corresponding to the received interest packets to generate the data packets including the searched contents. The second content nodes may transmit the generated data packets to the first content node through at least one relay content node (S670).

Next, when receiving the data packets from the second content nodes, the first content node may extract the contents included in the received data packets and provide the extracted contents to the user (S680).

In this case, when the same data packet is received again after receiving the data packets, the first content node discards the corresponding data packets.

The first content node may inform that the content transmission is started or finished by transmitting an identifier of the first content node and identifiers of the second content nodes providing the contents to the query server. Here, as the identifiers of the first content node and the second content nodes, the IP addresses may be used. The query server might use this information to calculate the load of each content node.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A system for providing information-centric networking services based on P2P, comprising:
a first content node configured to request the contents using a plurality of address information for the requested contents when receiving a request for contents from a user;
a plurality of second content nodes configured to provide the corresponding contents according to the request of the first content node; and
a query server configured to select at least one second content node for requesting the contents among the plurality of second content nodes corresponding to each of the plurality of address information.

2. The system of claim 1, wherein the first content node provides the plurality of address information corresponding to each of the second content nodes for the contents acquired by using a P2P protocol to the query server, and
requests the contents to at least one second content node by selecting at least one second content node for requesting the contents among the plurality of second content nodes corresponding to each of the plurality of address information from the query server.

3. The system of claim 1, wherein the first content node informs that content transmission starts by transmitting an identifier of the first content node and identifiers of the second content nodes providing the contents to the query server, when receiving the contents.

4. The system of claim 1, further comprising:
an information content node configured to store address information for the contents and provide the stored address information,
wherein the first content node calculates keys for the requested contents, confirms information related to an information content node storing the address information for the contents by using the calculated keys, and accesses the information content node to receive the plurality of address information for the contents.

5. The system of claim 1, further comprising:
a relay content node configured to relay packets for requesting the contents transmitted from the first content node and packets for providing the contents transmitted from the second content node.

6. The system of claim 5, wherein the relay content node stores reverse transmission information for the packets for requesting the contents.

7. The system of claim 1, wherein the query node selects at least one second content node among the plurality of second content nodes corresponding to the plurality of address information according to at least one predetermined determination criterion.

8. A system for providing information-centric networking services based on P2P, comprising:
an information providing unit configured to receive a plurality of address information for the requested contents when receiving a request for contents from a user;
a node determining unit configured to determine at least one content node for requesting the contents among a plurality of content nodes corresponding to each of the plurality of address information; and
a content processing unit configured to request the contents to at least determined content node and receive the requested contents from at least one content node.

9. The system of claim 8, wherein the information providing unit calculates keys for the requested contents, confirms information related to an information content node storing the address information for the contents by using the calculated keys, and accesses the information content node to receive the address information for the contents.

10. The system of claim 8, wherein the node determining unit provides the plurality of received address information for the contents to the query server, and
selects at least one second content node among the plurality of second content nodes corresponding to each of the plurality of address information from the query server.

11. A method for providing information-centric networking services based on P2P, comprising:
receiving, by a first content node, a plurality of address information for receiving the requested contents through a P2P protocol when receiving a request for contents from a user;
selecting, by a query server, at least one second content node for requesting the contents among a plurality of second content nodes corresponding to each of the plurality of address information;
requesting, by the first content node, the contents to at least one selected second content node; and
providing, by at least one second content node, the requested contents.

12. The method of claim 11, wherein in the receiving, the first content node calculates keys for the requested contents, confirms information related to an information content node storing the address information for the contents by using the calculated keys, and accesses the information content node to receive the plurality of address information for the contents.

13. The method of claim 11, wherein in the selecting,
the first content node provides the plurality of received address information for the contents to the query server, and
selects at least one second content node among the plurality of second content nodes corresponding to each of the plurality of address information from the query server.

14. The method of claim 11, further comprising:
informing, by the first content node, that content transmission starts by transmitting an identifier of the first content node and identifiers of the second content nodes providing the contents to the query server, when receiving the contents.

15. The method of claim 11, wherein the providing includes:
transmitting, by a relay content node, packets for requesting the contents transmitted from the first content node to the second content nodes; and
transmitting, by the relay content node, packets for providing the contents transmitted from the second content nodes to the first content node.

16. The method of claim 15, further comprising:
storing, by the relay content node, reverse transmission information for the packets for requesting the contents.

17. The method of claim 11, wherein in the selecting, the query server selects whether the contents are received from at least one of the plurality of second content nodes according to at least one predetermined determination criterion.

18. A method for providing information-centric networking services based on P2P, comprising:
receiving a plurality of address information for the requested contents when receiving a request for contents from a user;
requesting the contents to at least one content node for requesting the contents among the plurality of content nodes corresponding to each of the plurality of address information; and
receiving the requested contents from at least one content node.

19. The method of claim 18, wherein in the receiving, keys for the requested contents are calculated, information related to an information content node storing the address information for the contents by using the calculated keys is confirmed, and the address information for the contents is received by accessing the information content node.

20. The method of claim 18, wherein in the requesting,
the plurality of received address information for the contents is provided to the query server, and
at least one second content node among the plurality of second content nodes corresponding to each of the plurality of address information is selected from the query server to request the contents to at least one selected second content node.
